(19) United States
(12) Patent Application Publication
(10) Pub. No.: US 2013/0338055 A1
(43) Pub. Date: Dec. 19, 2013

(54) FOAMING BOOSTER AND DETERGENT COMPOSITION CONTAINING THE SAME

(71) Applicant: KAWAKEN FINE CHEMICALS CO., LTD., Tokyo (JP)

(72) Inventors: Shou OOSHIDA, Saitama (JP); Hiroki SUDA, Saitama (JP)

(73) Assignee: KAWAKEN FINE CHEMICALS CO., LTD., Tokyo (JP)

(21) Appl. No.: 13/684,853

(22) Filed: Nov. 26, 2012

(30) Foreign Application Priority Data
Jun. 15, 2012 (JP) 2012-135536

(51) Int. Cl. C11D 3/00; C11D 3/30

(52) U.S. Cl. CPC C11D 3/0094; C11D 3/30
USPC 510/499; 564/506

(57) ABSTRACT

The object of the present invention is to provide foam booster which the speed of lathering is excellent by using together with foaming surfactant such as anionic surfactants, nonionic surfactants, amphoteric surfactants, dipolar-ionic surfactants, semipolar surfactants and cationic surfactants, a detergent composition containing the same.

The present invention is a foam booster comprises aliphatic amine alkylene oxide adduct represented by the general formula (1):

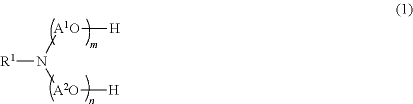

[wherein R¹ is an alkyl group having 6 to 10 carbon atoms, A¹O and A²O represent an oxyethylene group and/or an oxypropylene group and independently from each other, m and n are each independently a whole number more than 0, with 1≦m+n≦2.]

### BACKGROUND OF THE INVENTION

1. Technical Field

The present invention is to provide a foam booster with excellent foamabilyty and the speed of lathering. And it is the invention of detergent composition such as hair shampoo composition, body cleansing agent composition, detergent for dish, facing washing agent about using the booster.

2. Description of the Related Art

Detergent such as shampoo, soap, body shampoo, kitchen detergent and laundry detergent is required to be higher foam than high detergency.

Conventionally, A foaming surfactant in these detergents anionic surfactants, nonionic surfactants, amphoteric surfactants, dipolar-ionic surfactants, semipolar surfactants and cationic surfactants are used in the main component.

If used alone as a main component of these surfactants, in general, the speed of lathering, foam volume is not sufficient.

In recent years, such as fatty acid monoethanolamides (Japanese unexamined Patent Publication No11-080785(JP-11-080785-A)), mixture of polyoxypropylene fatty acid alkanolamides (Japanese unexamined Patent Publication No09-020740(JP-09-020740-A)), hydroxyalkylated polyhydric alcohol ether compound (Japanese unexamined Patent Publication No2003-096435(JP-2003-096435-A)) and glycerylether (Japanese unexamined Patent Publication No2001-107097 (JP-2001-107097-A)) in addition to the fatty acid diethanolamide and the alkylamine oxide which has been widely used.

However, even if these detergent composition, detergency, foam volume and foam quality is imploved, the speed of lathering is not satisfactory.

### SUMMARY OF THE INVENTION

The object of the present invention is to provide foam booster which the speed of lathering is excellent by using together with foaming surfactant such as anionic surfactants, nonionic surfactants, amphoteric surfactants, dipolar-ionic surfactants, semipolar surfactants and cationic surfactants, a detergent composition containing the same.

The inventors of the present invention have made extensive research to develop a new foam booster comparable to the conventional fatty acid alkanolamide compounds, and as a result, found that aliphatic amine alkylene oxide adduct can be used as a foam booster having the ability to improve the speed of lathering.

This is, the present invention is a foam booster comprises an aliphatic amine alkylene oxide adduct represented by the general formula (I):

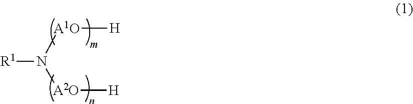

[whrein R¹ is an alkyl group having 6 to 10 carbon atoms, A¹O and A²O represent an oxyethylene group and/or an oxypropylene group and independently from each other, m and n are each independently a whole number more than 0, with 1≦m+n≦2.]

And it also includes matters relating to the production method of aliphatic amine alkylene oxide adduct.

For more information, a method for producing the foam booster is characterized by additional reacted in 1≦(A2+A3)≦2, wherein A2 and A3 represent respectively molar of A2 component and molar of A3 component as to 1 molar A1 component. In addition, A1, A2, A3 are shown below.

(A1) An aliphatic primary amine which linear or divergent having 6 to 10 carbon atoms

(A2)ethylene oxide

(A3)propylene oxide

The foam booster of the present invention can achieve the speed of lathering unprecedented, by mixing with the surfactant.

### BRIEF DESCRIPTION OF THE DROWINGS

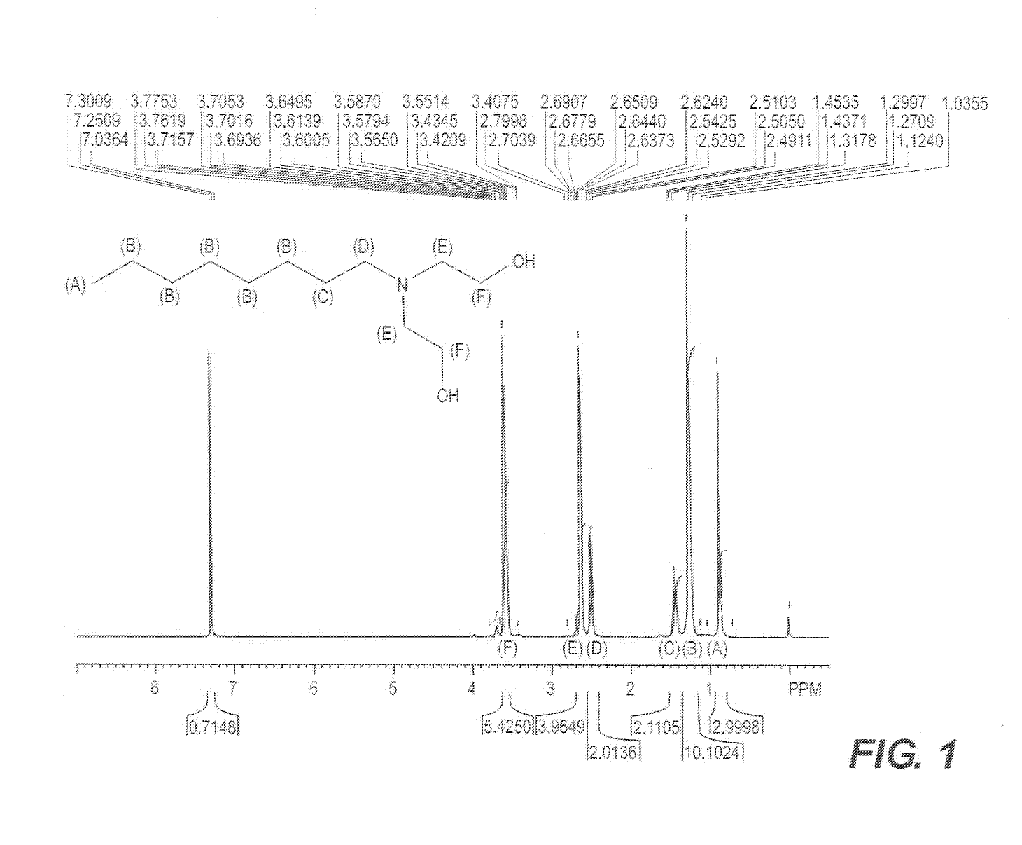

FIG. 1
¹H-NMR of POE(2) octylamine of Example 6

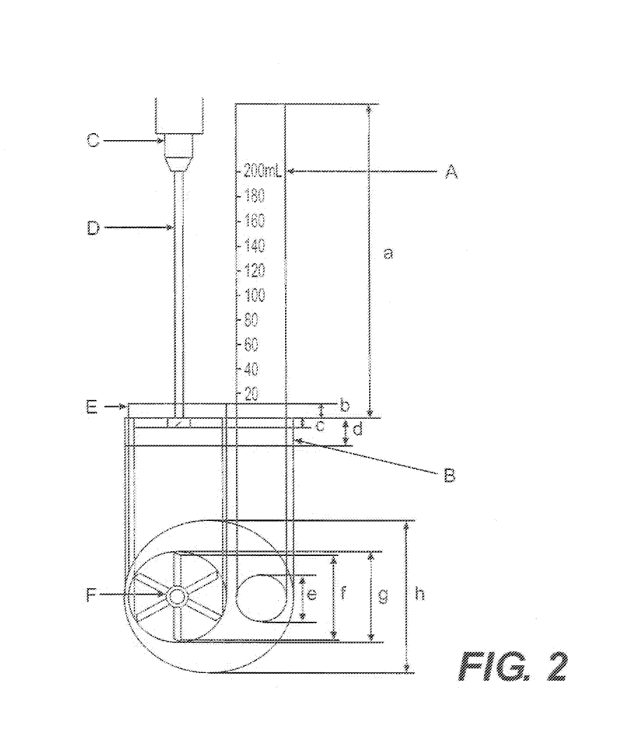

FIG. 2
The explanatory diagram of measurement apparatus used for the foaming speed evaluation.

### DETAILED DESCRIPTION OF THE PREFERRED EMBODIMENT

The foam booster of the present invention, is composed of an aliphatic amine alkylene oxide adduct represented by the general formula (I).

Further, the compounds is obtained by reacting in the range of 1 mol to 2 moles of ethylene oxide and propylene oxide to an aliphatic primary amine which linear or divergent having 6 to 10 carbon atoms.

If when the aliphatic primary amine is longer than 10 carbon atoms, it is undesirable because the speed of lathering and foamability effect do not appear.

And when the aliphatic primary amine is shorter than 6 carbon atoms, it is undesirable because foamability effect do not appear.

The foam booster of the present invention can be obtained by condensation of (A2) mol and/or (A3) mol of ethylene oxide and/or propylene oxide per 1 mol of an aliphatic primary amine used as a raw material.

At this time, the additional number of moles of alkylene oxide, it is important to react in the range of 1≦(A2+A3)≦2 for primary aliphatic amine as a raw material.

Furthermore, addition reacting in the range of 1≦(A2+A3)≦1.9 is more preferable.

If when the sum of A2+A3 is less than 1, it colored with time derived from raw materials, and amine odor occurred.

And when the sum of A2+A3 is more than 2, the product is colored, that is a problem with the quality of product. In addition, undesirable effects of the invention is reduced the speed of foaming significantly.

The foam booster of present invention may be exemplified by POE(1) hexylamine, POE(2) hexylamine, POP(1) hexylamine, POE(1)/POP(1) hexylamine, POP(2) hexylamine, POE(1) heptylamine, POE(2) heptylamine, POP(1) heptylamine, POE(1)/POP(1) heptylamine, POP(2) heptylamine, POE(1) octylamine, POE(2) octylamine, POP(1) octylamine, POE(1)/POP(1) octylamine, POP(2) octylamine, POE(1) nonylamine, POE(2) nonylamine, POP(1) nonylamine, POE(1)/POP(1) nonylamine, POP(2) nonylamine, POE(1) decylamine, POE(2) decylamine, POP(1) decylamine, POE(1)/POP(1) decylamine, POP(2) decylamine.

POE(2) octylamine is particularly preferably in order to have a excellent lathering.

The aliphatic amine alkylene oxide adduct of the present invention can be obtained by the addition of ethylene oxide or propylene oxide to various primary alkylamines.

The detergent composition containing the foam booster of the present invention will be explained below.

The foam booster of the present invention can achieve the speed of lathering unprecedented, by mixing with the surfactant.

The foaming surfactants may be exemplified by anionic surfactants, nonionic surfactants, amphoteric surfactants, dipolar-ionic surfactants and cationic surfactants.

Foaming surfactant alone, the foamability depends on the type For example, salts of fatty acid and N-acyl amino acid type surfactants are known poor foamabilyty.

In the detergent composition of the present invention, the content of the foam booster of the invention will be explained below.

In the detergent composition of present invention, the dry weight ratio of a component consisting of the foam booster of the present invention to a component consisting of the foaming surfactant is preferably in the range of from 0.5:19.5 to 6:14. And a more preferred ratio is the range of 2.0:18.0 to 3.0:17.0.

If when the rate of addition of the foam booster of the present invention is less than 0.5, it is undesirable because foamability effect is small. And when the rate is more than 6, it is undesirable because antiforming effect is large.

If the detergent composition of present invention is liquid detergent, it is desirable that the amount of total formulation of the foam booster of detergent composition and foaming surfactant is 0.1 to 50 wt % of overall composition. And a more preferred the amount of total formulation is 5 to 30 wt %.

Within a range that does not inhibit the effect of the invention, the invention of foam boosters can be formulated, according to the purpose with the components other than the detergent components within cosmetics and pharmaceuticals. For example, it can be formulated components such as the following. Polymer compound such as a cationic cellulose, hydroxypropyl cellulose, highly polymerized polyethylene oxide polymer etc. Antidandruff agents such as benzalkonium chloride, zinc pyrithionepanthenol. Chelating agent. Anti-inflammatory agents. Fungicides. Vitamines hydrolyzate thereof, legumes or protein hydrolyzate thereof, silk protein or obtained from pearl or shell with polar solvent extract of eucalyptus, a mother of pearl. Colorants as pigments. Moisturizer. Pearl and titanium oxide, kind extract protein obtained from the seeds of the plant extract, Asian ginseng extract, rice germ extract Fucus extract, camellia extract, aloe extract, chlorella extract, Antioxidants such as a ultraviolet absorber, perfume, powder.

The detergent composition of the present invention may be exemplified by body cleansing agent such as shampoo, hand soap, body shampoo and soap, kitchen detergent and laundry detergent.

### Example

Below, the present invention will be described in more detail by way of examples The present invention is not limited by these examples the present invention For our amount is indicated by weight percent unless otherwise specified Was fabricated alkylene oxide adduct of various aliphatic primary amine per mole ratios shown in Table 1 of the raw material alkylamine.

Added an alkylene oxide at a ratio shown in Table 1 for one mole of the raw material alkyl amine Production method is as follows In a reaction vessel of 1 liter stirred autoclave adding the ethylene oxide (EO) and propylene oxide (PO) at 150° C. for number of moles of shown in Table 1 for 1 mole of the raw material amine.

We were analyzed by ¹H-NMR the number of added moles of alkylene oxide FIG. 1 is a peak of ¹H-NMR measurement results of Example 6 (POE (2) octyl amine)

The integral ratio of CH3-(a) is proton 3 at the end of octylamine, proton integral ratio (e)-CH2-polyoxyethylene next to nitrogen is 397, so the average addition number (e)/2=199 In addition, the integral ratio of proton (f)-CH2-polyoxyethylene next to hydroxyl groups is 542, so the number of polyoxyethylene is added (f)/2=271 Thus, we have confirmed that the average addition molar number corresponding sample becomes 234, the molar ratio of the feed is being generated.

TABLE 1

| | The raw | Additional | Additional |
|---|---|---|---|
| | material | number of mole | number of |
| | alkylamine | EO | mole PO |
| Example 1 | Hexylamine | 1.0 | |
| Example 2 | Octylamine | 1.0 | |
| Example 3 | Decylamine | 1.0 | |
| Example 4 | Octylamine | 1.5 | |
| Example 5 | Octylamine | 2.0 | |
| Exsmple 25 | Hexylamine | 2.0 | |
| Example 26 | Decylamine | 2.0 | |
| Example 27 | Octylamine | 1.8 | |
| Example 28 | Octylamine | 1.9 | |
| Example 62 | Octylamine | 1.5 | 0.4 |
| Comparative | Pentylamine | 1.0 | |
| example 1 | | | |
| Comparative | Octylamine | 2.3 | |
| example 2 | | | |
| Comparative | Laurylamine | 1.0 | |
| example 3 | | | |

Foaming surfactant shown in Table 2 to Table 6 was adjusted according to their forming ratio of Examples and Comparative Examples We performed comparison for each sample the speed of foaming and foam volume etc Note that, in Table 3, “Softazoline LSB”, “Softazoline LAO”, “Softazoline CH”, “Softazoline CL” is amphoteric surfactants of Kawaken Fine Chemicals Co, Ltd.

Evaluation method is as follows

(A) Dynamic Surface Tension Measurement

We adjusted the surfactant concentration in the sample 1 weight percent solution Using the maximum bubble pressure method of dynamic surface tension meter (“BUBBLE PRESSURE TENSIOMETER-BP-2” manufactured by KRÜSS) As a result, time course curves were created, and the surface tension value for less than 1 second (an early dynamic area) was compared We compared the results of dynamic surface tension single component foaming surfactant and example (mixed component) If dynamic surface tension values are higher than the results of single component foaming surfactant, require many time surfactant adsorbed to the air water interface until the saturated adsorption Conversely, when the dynamic surface tension is lower than the result of a single component foaming surfactant, the time until the saturation adsorption is short From this it can be said, the foaming speed faster is latter Based on the results obtained was calculated the difference between the dynamic surface tension by eq. 1.

(eq.1)

Δγ=γ₀−γ (I)

In eq. 1, γ₀ is dynamic surface tension value of a single component foaming surfactant (mN/m), and γ is dynamic surface tension value of example (mN/m) When the eq. 1 value is large, the speed of foaming is fast The low value or negative value is slow The present inventors have found that in a value that is calculated by the eq. 1, when greater than or equal to 3 mN/m, there is a correlation the speed of foaming clearly in sensory evaluation that particularly fast Thus, for high speed foam, it is more than 3 mN/m are preferred in this evaluation.

(B) Volume of Foam

We sensory evaluation was carried out by hand washing with detergent ten panelists for each sample Evaluated on the basis of Comparative Example 6 of Table 1, we were evaluated according to the following evaluation When a large amount of foam volume is ∘, normal amount is Δ, small amount is x

(C) Usability Test

For a sample of each detergent agents, by ten panelists, tested for use by hand-washing, (Volume of foam) foaming during use, foam quality, feel during rinsing, general feeling The evaluation was made with a standard 3-point comparison of the five cases in Table 1 And relative evaluation out of 5, was calculated the average score of the evaluation results The calculated average value was expressed as follow.

Very good in the case of more than 45 point (⊚)
Good in the case of 45˜35 point (∘)
Usually in the case of 35˜30 point (Δ)
Failure (x) in the case of less than 30 point

(D) Low Temperature Stability

Each sample was allowed to stand for 12 hours at −5° C. Then the sample observed state.

Evaluated in two stages:

x what was cloudy, the crystallization

∘ which holds the form of a clear solution

(E) The Speed of Foaming

We were adjusted with distilled water to total surfactant concentration one weight percent so that the detergent mixing ratio described in Table 4-6 200 mL aqueous solution was weighed into a vessel 200 mL of the foaming equipment (B in FIG. 2) was indicated in FIG. 2, thereby rotating the paddle blades inclined sheets 6 (F in FIG. 2), collected in 200 mL graduated cylinder (A in FIG. 2) we measured the time (seconds) when the amount of foam has reached 100 mL We say time to reach 100 mL this measurement is as fast, the speed of foaming is fast.

(F) Usability Test

Similar to the evaluation of (E), for each sample by ten panelists, for use by hand-washing tests, we have conducted a sensory test of the rise of the foam during use Table 6 Evaluation of foaming detergent was the standard three points Comparative Example 19 Rate of foaming detergent Table 5 Comparative Example 15, Comparative Example 11 of Table 4 Evaluation of the foaming detergent And relative evaluation out of 5, was calculated the average score of the evaluation results The calculated average value was expressed as follow.

Very good in the case of more than 45 point (⊚)

Good in the case of 45˜35 point (∘)

Usually in the case of 35˜30 point (Δ)

Failure (x) in the case of less than 30 point

TABLE 2

| | Example | | | | | | | | | | | Comparative example | | | | |
|---|---|---|---|---|---|---|---|---|---|---|---|---|---|---|---|---|
| material | 6 | 7 | 8 | 9 | 10 | 11 | 12 | 13 | 14 | 15 | 16 | 4 | 5 | 6 | 7 | 8 |
| Example1 | 3.0 | | | | | | | | | | | | | | | |
| Example2 | | 3.0 | | | | 3.0 | 3.0 | 3.0 | 3.0 | 3.0 | 3.0 | | | | | |
| Example3 | | | 3.0 | | | | | | | | | | | | | |
| Example4 | | | | 3.0 | | | | | | | | | | | | |
| Example5 | | | | | 3.0 | | | | | | | | | | | |
| Comparative | | | | | | | | | | | | 3.0 | | | | |
| example1 | | | | | | | | | | | | | | | | |
| Comparative | | | | | | | | | | | | | 3.0 | | | |
| example2 | | | | | | | | | | | | | | | | |
| Comparative | | | | | | | | | | | | | | 3.0 | | |
| example3 | | | | | | | | | | | | | | | | |
| Lauroyl | | | | | | | | | | | | | | | 3.0 | |
| diethanolamide | | | | | | | | | | | | | | | | |
| Ethythexyl- | | | | | | | | | | | | | | | | 3.0 |
| grycerin | | | | | | | | | | | | | | | | |
| Fatty acid salt | 17.0 | 17.0 | 17.0 | 17.0 | 17.0 | | | | | | | 17.0 | 17.0 | 17.0 | 17.0 | 17.0 |
| Sodium Lauroyl | | | | | | 17.0 | | | | | | | | | | |
| methylamino | | | | | | | | | | | | | | | | |
| propionate | | | | | | | | | | | | | | | | |
| POE sodium- | | | | | | | 17.0 | | | | | | | | | |
| laurylsurfate | | | | | | | | | | | | | | | | |
| Lauroyl | | | | | | | | 17.0 | | | | | | | | |
| sarcosinate | | | | | | | | | | | | | | | | |
| Lauroyl | | | | | | | | | 17.0 | | | | | | | |
| glutamate | | | | | | | | | | | | | | | | |
| alkylether- | | | | | | | | | | 17.0 | | | | | | |
| carboxylate | | | | | | | | | | | | | | | | |
| Lauroymethyl- | | | | | | | | | | | 17.0 | | | | | |
| taurine | | | | | | | | | | | | | | | | |
| pH | 10.0 | 10.0 | 10.0 | 10.0 | 10.0 | 6.5 | 6.5 | 6.5 | 6.5 | 6.5 | 6.5 | 10.0 | 10.0 | 10.0 | 10.0 | 10.0 |
| Refined water | up to | up to | up to | up to | up to | up to | up to | up to | up to | up to | up to | up to | up to | up to | up to | up to |
| | 100% | 100% | 100% | 100% | 100% | 100% | 100% | 100% | 100% | 100% | 100% | 100% | 100% | 100% | 100% | 100% |
| The speed | 1.2 | 7.2 | 4.2 | 4.9 | 3.4 | 6.9 | 8.0 | 8.1 | 7.5 | 6.5 | 8.3 | −2.1 | 0.8 | 1.2 | 0.4 | 3.2 |
| of foaming | | | | | | | | | | | | | | | | |
| (Δ γ [mN/m]) | | | | | | | | | | | | | | | | |
| Volume of foam | Δ | ◯ | ◯ | ◯ | ◯ | ◯ | ◯ | ◯ | ◯ | ◯ | ◯ | X | Δ | Δ | X | Δ |
| foam quallity | Coarse | Ordi- | Ordi- | Ordi- | Ordi- | Ordi- | Ordi- | Coarse | Coarse | Coarse | Ordi- | Coarse | Coarse | Fine | Ordi- | Coarse |
| | | nary | nary | nary | nary | nary | nary | | | | nary | | | | nary | |
| Usability test | Δ | ⊚ | ◯ | ◯ | ◯ | ⊚ | ⊚ | ⊚ | ⊚ | ⊚ | ⊚ | Δ | Δ | Δ | Δ | ◯ |
| Low temperature | ◯ | ◯ | ◯ | ◯ | ◯ | ◯ | ◯ | ◯ | ◯ | ◯ | ◯ | ◯ | ◯ | ◯ | ◯ | ◯ |
| stability | | | | | | | | | | | | | | | | |

TABLE 3

| | Example | | | | | | | |
|---|---|---|---|---|---|---|---|---|
| material | 17 | 18 | 19 | 20 | 21 | 22 | 23 | 24 |
| Example2 | 3.0 | 3.0 | 3.0 | 3.0 | 3.0 | 3.0 | 3.0 | 3.0 |
| Softazoline LSB | 17.0 | | | | | | | |
| Lauryl dimethylhydroxy- | | 17.0 | | | | | | |
| surfobetaine | | | | | | | | |
| Softazoline LAO | | | 17.0 | | | | | |
| Lauryl dimethylamineoxide | | | | 17.0 | | | | |
| Softazoline CH | | | | | 17.0 | | | |
| Softazoline CL | | | | | | 17.0 | | |
| Laurylbetaine | | | | | | | 17.0 | |
| Alkylaminoacid based surfactant | | | | | | | | 17.0 |
| pH | 6.5 | 6.5 | 6.5 | 6.5 | 6.5 | 6.5 | 6.5 | 6.5 |
| Refined water | up to 100% | up to 100% | up to 100% | up to 100% | up to 100% | up to 100% | up to 100% | up to 100% |
| Speed of foaming (Δ γ [mN/m]) | 7.6 | 7.8 | 6.8 | 6.5 | 7.8 | 8.0 | 8.1 | 8.2 |
| Volume of foam | ◯ | ◯ | ⊚ | ◯ | ⊚ | ⊚ | ⊚ | ⊚ |
| Foam quallity | Coarse | Coarse | Coarse | Coarse | Coarse | Coarse | Coarse | Coarse |
| Usabilitytest | ◯ | ◯ | ◯ | Δ | ◯ | ⊚ | ◯ | ◯ |
| Low temperature stability | ◯ | ◯ | ◯ | ◯ | ◯ | ◯ | ◯ | ◯ |

A comparison of example 4-6 and Comparative Examples 6-10, even when mixed with the same ratio an various polyoxyalkylene alkylamine differences occurred with respect to the foam volume and speed of foaming. Improved foam volume and speed of foaming example 7, 9, 10 shown by R1 is a C8 of eq 1 is particularly noticeable Improved foam volume and speed of foaming example 7, 9, 10 shown by caprylyl residue is particularly noticeable. The effect of the invention is lost, when increasing the number of added moles of alkylene oxide, shown in Comparative Example 5 and Example 7, 9, 10 The effect of the invention is occurs for polyoxyealkylene alkyl amine has a specific structure Moreover, the invention is excellent speed of foaming, comparing to alkyl glyceryl ether and fatty acid alkanolamides, shown in Comparative Examples 7 and 8 According to example 17-24 of Table 3, and example 11-16 in Table 2, the effect of foam booster and the speed of foaming in polyoxyalkylene alkylamine structure has a specific performance to various foaming detergent.

TABLE 4

| | Example | | | | | | | | | | Comparative example | | | |
|---|---|---|---|---|---|---|---|---|---|---|---|---|---|---|
| material | 29 | 30 | 31 | 32 | 33 | 34 | 35 | 36 | 37 | 63 | 9 | 10 | 11 | 12 |
| Example1 | 3.0 | | | | | | | | | | | | | |
| Example2 | | 3.0 | | | | | | | | | | | | |
| Example3 | | | 3.0 | | | | | | | | | | | |
| Example4 | | | | 3.0 | | | | | | | | | | |
| Example5 | | | | | 3.0 | | | | | | | | | |
| Example25 | | | | | | 3.0 | | | | | | | | |
| Example26 | | | | | | | 3.0 | | | | | | | |
| Example27 | | | | | | | | 3.0 | | | | | | |
| Example28 | | | | | | | | | 3.0 | | | | | |
| Example62 | | | | | | | | | | 3.0 | | | | |
| Comparative example2 | | | | | | | | | | | 3.0 | | | |
| Comparative example3 | | | | | | | | | | | | 3.0 | | |
| Amisol CME (*1) | | | | | | | | | | | | | 3.0 | |
| Nonsal LK-30(*2) | 17.0 | 17.0 | 17.0 | 17.0 | 17.0 | 17.0 | 17.0 | 17.0 | 17.0 | 17.0 | 17.0 | 17.0 | 17.0 | 17.0 |
| pH | 10.0 | 10.0 | 10.0 | 10.0 | 10.0 | 10.0 | 10.0 | 10.0 | 10.0 | 10.0 | 10.0 | 10.0 | 10.0 | 10.0 |
| Refined water | up to | up to | up to | up to | up to | up to | up to | up to | up to | up to | up to | up to | up to | up to |
| | 100% | 100% | 100% | 100% | 100% | 100% | 100% | 100% | 100% | 100% | 100% | 100% | 100% | 100% |
| Time of reaching 100 mL (Second) | 23.2 | 20.3 | 21.3 | 20.0 | 21.0 | 23.0 | 19.4 | 18.4 | 20.1 | 20.0 | 22.0 | 24.5 | 22.5 | 26.5 |
| Usability test | ◯ | ⊚ | ◯ | ⊚ | ◯ | ◯ | ◯ | ⊚ | ⊚ | ⊚ | Δ | X | Δ | X |

(*1) Amisol CME(Kawaken finechemicals Co, Ltd): Cocoyl monoethanolamide
(*2)Nonsal LK-30(NOF Corpolation): Potassium Cocoylate

TABLE 5

| | Example | | | | | | | | | | Comparative example | | | |
|---|---|---|---|---|---|---|---|---|---|---|---|---|---|---|
| material | 38 | 39 | 40 | 41 | 42 | 43 | 44 | 45 | 46 | 64 | 13 | 14 | 15 | 16 |
| Example1 | 3.0 | | | | | | | | | | | | | |
| Example2 | | 3.0 | | | | | | | | | | | | |
| Example3 | | | 3.0 | | | | | | | | | | | |
| Example4 | | | | 3.0 | | | | | | | | | | |
| Example5 | | | | | 3.0 | | | | | | | | | |
| Example25 | | | | | | 3.0 | | | | | | | | |
| Example26 | | | | | | | 3.0 | | | | | | | |
| Example27 | | | | | | | | 3.0 | | | | | | |
| Example28 | | | | | | | | | 3.0 | | | | | |
| Example62 | | | | | | | | | | 3.0 | | | | |
| Comparative example2 | | | | | | | | | | | 3.0 | | | |
| Comparative example3 | | | | | | | | | | | | 3.0 | | |
| Amisol CME | | | | | | | | | | | | | 3.0 | |
| Amisoft CS-22(*3) | 17.0 | 17.0 | 17.0 | 17.0 | 17.0 | 17.0 | 17.0 | 17.0 | 17.0 | 17.0 | 17.0 | 17.0 | 17.0 | 17.0 |
| pH | 6.0 | 6.0 | 6.0 | 6.0 | 6.0 | 6.0 | 6.0 | 6.0 | 6.0 | 6.0 | 6.0 | 6.0 | 6.0 | 6.0 |
| Refined water | up to | up to | up to | up to | up to | up to | up to | up to | up to | up to | up to | up to | up to | up to |
| | 100% | 100% | 100% | 100% | 100% | 100% | 100% | 100% | 100% | 100% | 100% | 100% | 100% | 100% |
| Time of reaching 100 mL (Second) | 23.7 | 21.2 | 20.7 | 21.3 | 21.8 | 22.6 | 21.3 | 20.3 | 21.1 | 20.8 | 23.9 | 78.1 | 23.7 | 24.5 |
| Usability test | ◯ | ⊚ | ◯ | ⊚ | ◯ | ◯ | ◯ | ⊚ | ⊚ | ⊚ | Δ | X | Δ | X |

(*3)Amisoft CS-22(Ajinomoto Co, Inc): Disodium cocoyl glutamate

TABLE 6

| | Example | | | | | | | | | | Comparative example | | | |
|---|---|---|---|---|---|---|---|---|---|---|---|---|---|---|
| material | 47 | 48 | 49 | 50 | 51 | 52 | 53 | 54 | 55 | 65 | 17 | 18 | 19 | 20 |
| Example1 | 3.0 | | | | | | | | | | | | | |
| Example2 | | 3.0 | | | | | | | | | | | | |
| Example3 | | | 3.0 | | | | | | | | | | | |
| Example4 | | | | 3.0 | | | | | | | | | | |
| Example5 | | | | | 3.0 | | | | | | | | | |
| Example25 | | | | | | 3.0 | | | | | | | | |
| Example26 | | | | | | | 3.0 | | | | | | | |
| Example27 | | | | | | | | 3.0 | | | | | | |
| Example28 | | | | | | | | | 3.0 | | | | | |
| Example62 | | | | | | | | | | 3.0 | | | | |
| Comparative example2 | | | | | | | | | | | 3.0 | | | |
| Comparative example3 | | | | | | | | | | | | 3.0 | | |
| Amicol CME | | | | | | | | | | | | | 3.0 | |
| Emal E-27C(*4) | 17.0 | 17.0 | 17.0 | 17.0 | 17.0 | 17.0 | 17.0 | 17.0 | 17.0 | 17.0 | 17.0 | 17.0 | 17.0 | 17.0 |
| pH | 6.0 | 6.0 | 6.0 | 6.0 | 6.0 | 6.0 | 6.0 | 6.0 | 6.0 | 6.0 | 6.0 | 6.0 | 6.0 | 6.0 |
| Refined water | up to | up to | up to | up to | up to | up to | up to | up to | up to | up to | up to | up to | up to | up to |
| | 100% | 100% | 100% | 100% | 100% | 100% | 100% | 100% | 100% | 100% | 100% | 100% | 100% | 100% |
| Time of reaching 100 mL (Second) | 22.3 | 18.1 | 20.2 | 18.0 | 21.9 | 23.2 | 21.3 | 20.7 | 21.5 | 21.0 | 23.6 | 23.9 | 26.5 | 26.7 |
| Usability test | ◯ | ◯ | ◯ | ⊚ | ◯ | ◯ | ◯ | ◯ | ⊚ | ⊚ | Δ | X | Δ | X |

(*4)Emal E-27C(Kao Corpolation): POE laurylethersulfuric acid ester sodium salt

Comparing the “number of seconds upon reaching 100 mL” comparative example 2.3, example 1-5, 25-38 described in Table 4, Table 5, Table 6, polyoxyalkylene alkylamine various be formulated in the same ratio foaming detergent, difference to the amount of foaming and speed of foaming depending on the amount of alkylene oxide adduct and chain length. Improvement in the amount of foaming and speed of foaming is remarkable example 2, 4, 5, 27, 28, among examples of C8 is a compound represented by R1 of eq 1 in particular. In addition, the effect of the invention disappears when compared to Example 2 and Comparative Example 2, a larger number of added moles of alkylene oxide or smaller. This indicates that occur specifically to polyoxyethylene alkylamine has a specific structure. Moreover, the effect is also superior compared to the foaming effect to the fatty acid alkanol amides are conventionally used as foam booster and the speed of foaming.

We developed a detergent formulation of the following combination of various types of foaming detergent and the invention foam booster.

Comprehensive evaluation was good grades indicate the amount of foam excellent speed of foaming.

### Example 56

### Shampoo Composition

A shampoo composition was prepared in the following composition.

| | |
|---|---|
| POE(3) laurylethersulfuric acid ester | 15.00% |
| sodium salt | |
| Cocamidepropylbetaine | 4.00% |
| Polyoxyethylene alkylamine of example2 | 5.00% |
| Ethylenglycol distearate | 0.50% |
| Cationized cellulose | 0.50% |
| Quatanium-33 | 1.00% |
| Cetyl alchol | 0.60% |
| Dimethylpolysiloxane(20cs) | 1.00% |
| Glutamic acid | pH = 4.0(5% diluted solution) |
| Antiseptic | 0.20% |
| Color addictive | Moderate amount |
| Perfume | 0.30% |
| Refined water | An amount necessary to |
| | adjust the total amount |
| | to 100% |

### Example 57

### Germicidal Hand Soap Composition

A germicidal hand soap composition was prepared in the following composition.

| | |
|---|---|
| Lauric acid | 5.50% |
| Lauramide propyldimethylamineoxide | 3.00% |
| 30% solution of POE(3) lauryletheracetate | 3.00% |
| Benzalkonium chloride | 1.00% |
| Benzethonium chloride | 0.50% |
| poluoxyethylene alkylamine of example 4 | 2.00% |
| Sodium cocoampho propionate | 9.50% |
| Triethanolamine | An amount sufficient to |
| | adjust pH = 7.8 |
| Glycerin | 3.00% |
| Refined water | An amount necessary to adjust |
| | the total amount to 100% |

### Example 58

### Body Soap

A body soap composition was prepared in the following composition.

| | |
|---|---|
| Lauric acid | 6.00% |
| Myristic acid | 8.00% |
| Palmitic acid | 2.00% |
| Potassium hydroxide | 3.89% |
| Lauramide prorylhydroxysultaine | 3.00% |
| Potassium lauroylmethylamino propionate | 2.00% |
| Polyoxyethylene alkylamine of example 27 | 3.00% |
| Pottassium cocoyl grysicionate | 0.50% |
| Glycerin | 5.00% |
| Ethyleneglycol distearate | 2.00% |
| Hydroxypropylmethylcellulose | 2.00% |
| Sodium(4)EDTA | 0.20% |
| Methylparabene | 0.20% |
| Refined water | An amount necessary to |
| | adjust the total amount |
| | to 100% |

### Example 59

### Transparent Solid Detergent Composition

A transparent solid detergent composition was prepared in the following composition.

| | |
|---|---|
| Sodium tallowate | 32.00% |
| Sodium cocoylate | 8.00% |
| Sodium cocoylglutamate | 2.00% |
| Polyoxyethylene alkylamine of example 4 | 5.00% |
| Grycerin | 8.00% |
| Sucrose | 10.00% |
| Ethanol | 15.00% |
| Lauramide propyldomethylamineoxide | 7.00% |
| Hydroxy ethane diphosphonic acid | 0.50% |
| Refined water | An amount necessary to adjust |
| | the total amount to 100% |

To obtain a transparent solid detergent and dried for up to 80% by weight immediately after production

### Example 60

### Solid Detergent Composition

A solid detergent composition was prepared in the following composition.

| | |
|---|---|
| Amisoft GS-11 (Manufactured by Ajinomoto Co.,Inc.) | 49.10% |
| Amisoft CK-11 (Manufactured by Ajinomoto Co.,Inc.) | 25.00% |
| Behenyl alchol | 2.00% |
| Isostearyl alchol | 3.00% |
| Allamtoin | 0.20% |
| Polyoxyethylene alkylamine of example 27 | 15.00% |
| EDTA•2Na | 0.10% |
| Titanium oxide | 0.10% |
| Refined water | 5.50% |

### Example 61

### Detergent for Kitchen

A detergent for kitchen composition was prepared in the following composition.

| | |
|---|---|
| POE(2) laurylethersulfuric acid ester sodium salt | 50.00% |
| Cocamidepropylbetaine | 30.00% |
| Cocoyl monoethanolamide | 6.00% |
| Polyoxyethylene alkylamine of example 28 | 1.00% |
| EDTA•2Na | 0.10% |
| Citric acid | 0.10% |
| Refined water | 12.80% |

The foam booster of the present invention is excellent in foaming speed by using foaming surfactant. Therefore, it is very promising as a foaming agent of detergent composition.

What is claimed is:

1. A foam booster, comprising an aliphatic primary amine alkylene oxide adduct represented by general formula (I): 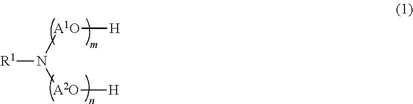
[wherein R¹ is an alkyl group having 6 to 10 carbon atoms, A¹O and A²O represent an oxyethylene group and/or an oxypropylene group and independently from each other, m and n are each independently a whole number more than 0, with 1≦m+n≦2.]

2. The foam booster according to claim 1, wherein R¹ in the formula (I) is a linear alkyl group having 8 carbon atoms

3. A method for producing a foam booster is characterized by additional reacted in 1≦(A2+A3)≦2, wherein A2 and A3 represent respectively molar of A2 component and molar of A3 component as to 1 molar A1 component.
(A1) An aliphatic primary amine which linear or divergent having 6 to 10 carbon atoms
(A2) ethylene oxide
(A3) propylene oxide

4. The method for producing the foam booster according to claim 3, wherein (A1) is a linear alkyl group having 8 carbon atoms.

5. The method for producing the foam booster according to claim 3 is characterized by additional reacted in 1≦(A2+A3)≦1.9, wherein A2 and A3 represent respectively molar of A2 component and molar of A3 component as to 1 molar A1 component.
(A1) A linear alkyl group having 8 carbon atoms.

6. A detergent composition, comprising:
the foam booster of claim 1; and at least one surfactant selected from the group consisting of anionic surfactants, nonionic surfactants other than those of compounds of formula (1) in claim 1, amphoteric surfactants, dipolar-ionic surfactants, semipolar surfactants and cationic surfactants.
